(19) United States
(12) Patent Application Publication
(10) Pub. No.: US 2005/0009574 A1
(43) Pub. Date: Jan. 13, 2005

(54) Integrated wireless and wired hands-free device for a mobile phone

(76) Inventor: Hsi Yang Lin, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/614,165

(22) Filed: Jul. 8, 2003

(51) Int. Cl. H04M 1/00

(52) U.S. Cl. 455/569.2; 455/41.1; 455/550.1

(57) ABSTRACT

An integrated wireless and wired hands-free device for a mobile phone has a blue-tooth wireless transceiving module. When the blue-tooth wireless transceiving module receives an incoming signal, it sends an activation control signal to an audio mix switch, which switches on a voice transmission channel to be used by the blue-tooth wireless transceiving module. The incoming signal is transmitted through the audio mix switch and a control device and finally output by a loudspeaker to be heard by a user, who can then achieve intercommunication via a microphone. The intercom voice signal is transmitted through the control device, the audio mix switch and the blue-tooth transceiving module and finally sent out by the blue-tooth transceiving module. The audio mix switch is also connected to a wired transmission device providing connection with a mobile phone lacking the blue-tooth wireless transmission function to accomplish reception of an incoming signal and intercommunication.

### FIELD OF THE INVENTION

The present invention relates to an integrated wireless and wired hands-free device for a mobile phone and, more particularly, to a hands-free device used for mobile phones with and without the blue-tooth wireless function. The hands-free device for a mobile phone can automatically switch between wireless and wired transmission modes according to the transmission function of a mobile phone.

### BACKGROUND OF THE INVENTION

Along with quick development of mobile communications, the convenience in lives of people increases day by day. Nowadays, most people have mobile phones. However, using a mobile phone in a car or on a motorcycle is a very dangerous behavior, which may cause traffic accidents. Therefore, hands-free devices have been developed to solve this problem. Through the design of hands-free devices, drivers can directly achieve intercommunication without the need to stop the car or hold the mobile phone with hand when an incoming call arrives. That is, existent hands-free devices are convenient and safe, and provide a safeguard in driving.

As shown in FIG. 1, a conventional hands-free device of car mobile phone comprises a mobile phone seat 10 for placement of a mobile phone 12. The mobile phone seat 10 is connected to a control device 14. The control device 14 is connected to a power input device 16 for supply of power, a microphone 18, a loudspeaker 20, and an antenna 22 for receiving signals. When an incoming call arrives, the driver needs only to answer the incoming call through the microphone 18 and the loudspeaker 20 without the need of holding the mobile phone 12 in a hand. However, for the conventional hands-free device for a mobile phone, the user needs to first place the mobile phone 12 in the mobile phone seat 10 or connect the mobile phone 10 to the control device 4 with a mobile phone connection cable. The user may forget to remove the mobile phone 12 when exiting the car, resulting in inconvenience of use. Although some hands-free devices for a mobile phone have the blue-tooth wireless transmission function, they can only be used together with mobile phones having also the blue-tooth wireless transmission function, hence limiting the usage and thus lowering its practicality.

Accordingly, the present invention aims to propose an integrated wireless and wired hands-free device for a mobile phone to solve the problems in the prior art.

### SUMMARY OF THE INVENTION

The primary object of the present invention is to provide an integrated wireless and wired hands-free device for a mobile phone, whereby a user does not need to install a mobile phone in the hands-free device to avoid the inconvenience of detaching the mobile phone from the hands-free device when the user exits a car, hence enhancing the convenience of use.

The secondary object of the present invention is to provide an integrated wireless and wired hands-free device for a mobile phone, which can be used for mobile phones without the wireless transmission function to enhance the use range and practicality.

To achieve the above objects, the present invention provides an integrated wireless and wired hands-free device for a mobile phone, which comprises an antenna for receiving an incoming signal. The antenna is used to transmit the incoming signal to a blue-tooth wireless transceiving module. When the blue-tooth wireless transceiving module receives the incoming signal, it sends an activation control signal to an audio mix switch, which switches on a voice transmission channel to be used by the blue-tooth wireless transceiving module. The incoming signal is transmitted through the audio mix switch to a control device, which then transmits the incoming signal to a loudspeaker for output to be heard by a user, who can then achieve intercommunication via a microphone. The microphone is used to receive and transmit an intercom voice signal, which is transmitted through the control device, the audio mix switch, the blue-tooth transceiving module and the antenna, and finally is sent out by the antenna. The audio mix switch is further connected to a wired transmission device providing connection with a mobile phone lacking the blue-tooth wireless transmission function to accomplish reception of an incoming call and intercommunication. When the blue-tooth wireless transceiving module: does not send out an activation control signal to the audio mix switch, the audio transmission channel is used by a wired socket to accomplish reception of an incoming call and intercommunication of the mobile phone.

### BRIEF DESCRIPTION OF THE DRAWINGS

The various objects and advantages of the present invention will be more readily understood from the following detailed description when read in conjunction with the appended drawings, in which:

FIG. 1 is a diagram showing the use of a conventional car hands-free device for a mobile phone installed in a car; and

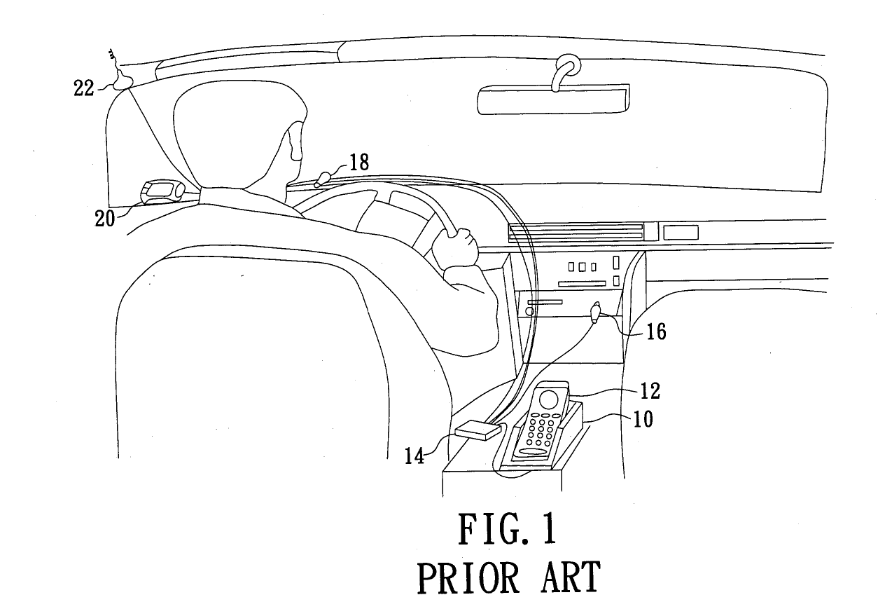

FIG. 2 is a block diagram of a preferred embodiment of the present invention.

### DETAILED DESCRIPTION OF THE PREFERRED EMBODIMENTS

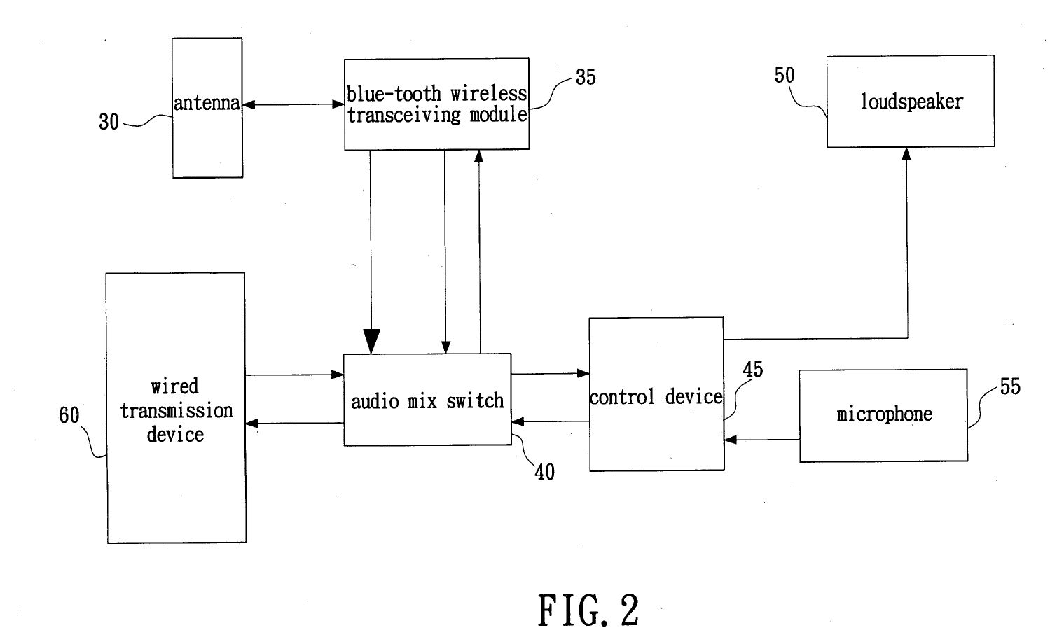

As shown in FIG. 2, when a mobile phone having the blue-tooth wireless transmission function has an incoming call, an antenna 30 is used to receive and transmit the incoming signal to a blue-tooth wireless transceiving module 35, which sends an: activation control signal (indicated by the bold black arrow in the figure) to an audio mix switch 40. After the audio mix switch 40 receives the activation control signal, it switches on a voice transmission channel to be used by the blue-tooth wireless transceiving module 35 for transmitting the incoming signal to the audio mix switch 40. The audio mix switch 40 is used to transmit the incoming signal to a control device 45, which then transmits the incoming signal to a loudspeaker 50 for output to be heard by a user. In this embodiment, a loudspeaker volume adjustment device. (not shown) is also provided to adjust the output volume of the loudspeaker 50.

When the user hears the sound of the incoming call from the loudspeaker 50, he can speak toward a microphone 55 to respond to the incoming call. The microphone 55 is used to receive and transmit the intercommunication voice signal of the user to the control device 45, which then transmits the intercommunication voice signal to the audio mix switch 40. Next, the audio mix switch 40 transmits the intercommunication voice signal to the blue-tooth wireless transceiving module 35, which then emits out the intercommunication voice signal via the antenna 30. In this embodiment, the microphone 55 is an external one, which can be conveniently placed at an appropriate position in a car for clear reception of the intercommunication voice content.

The audio mix switch 40 of the present invention also has a wired transmission device 60 for connection with a mobile phone having no blue-tooth wireless transmission function to accomplish reception of incoming call and transmission of intercommunication voice. When the mobile phone connected to the wired transmission device 60 has an incoming call, the incoming signal is transmitted through the audio mix switch 40, the control device 45 and the loudspeaker 50 in this order and finally is output by the loudspeaker 50. The intercommunication voice content is received by the microphone 55, and is transmitted through the control device 45 and the audio mix switch 40 in this order and finally sent out by the wired transmission device 60. In this way, the use range of hands-free devices for a mobile phone can be increased to enhance its practicality. The audio mix switch 40 of the present invention ordinarily switches on the voice transmission channel to be used by the wired transmission device 60. When the blue-tooth wireless transceiving module 35 sends an activation control signal to the audio mix switch 40, the audio mix switch 40 then switches on the voice transmission channel to be used by the blue-tooth wireless transceiving module 35.

To sum up, the present invention proposes an integrated wireless and wired hands-free device for a mobile phone, which makes use of the blue-tooth wireless transmission technique to avoid the inconvenience of detaching the mobile phone from the hands-free device when the user gets off a car, hence enhancing the convenience of use. Additionally, the wired transmission device 60 is also provided for connection with a mobile phone without the blue-tooth wireless transmission function to accomplish reception of an incoming call and transmission of intercommunication voice, hence increasing the use range of hands-free device for a mobile phone and enhancing the practicality thereof.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

1. An integrated wireless and wired hands-free device for a mobile phone, comprising:
a blue-tooth wireless transceiving module used to receive and output an incoming signal and send out an activation control signal;
an audio mix switch used for receiving said activation control signal to switch a voice transmission channel to be used by said blue-tooth wireless transceiving module for receiving and transmitting said incoming signal from said blue-tooth wireless transceiving module;
a control device used to receive and transmit said incoming signal from said audio mix switch;
a loudspeaker used to receive said incoming signal from said control device for output to be heard by a user;
a microphone used to receive and transmit an intercom voice signal of the user, said intercom voice signal being transmitted through said control device, said audio mix switch and said blue-tooth wireless transceiving module and finally sent out by said blue-tooth wireless transceiving module; and
a wired transmission device connected to said audio mix switch, said wired transmission device being connected to a mobile phone without the wireless transmission function so that said mobile phone can accomplish voice transmission via said wired transmission device, said voice transmission channel being used by said wired transmission device to accomplish reception of an incoming call and intercommunication of said mobile phone when said blue-tooth wireless transceiving module does not send out said activation control signal to said audio mix switch.

2. The integrated wireless and wired hands-free device for a mobile phone as claimed in claim 1, wherein said incoming signal is received by an antenna and transmitted to said blue-tooth wireless transceiving module, and said blue-tooth wireless transceiving module transmits said intercom voice signal to said antenna for emission.

3. The integrated wireless and wired hands-free device for a mobile phone as claimed in claim 1, wherein a loudspeaker volume adjustment device is further provided to adjust the output volume of said loudspeaker.

4. The integrated wireless and wired hands-free device for a mobile phone as claimed in claim 1, wherein said microphone is an external one and can be placed in an appropriate position in a car.
